(19) United States
(12) Patent Application Publication
(10) Pub. No.: US 2006/0108255 A1
(43) Pub. Date: May 25, 2006

(54) Manufacturing method of a packing cushion for electric equipments and a structure of the packing cushion

(76) Inventor: Cheng-Kang Chu, Hsinchu City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/994,676

(22) Filed: Nov. 22, 2004

(51) Int. Cl. B65D 81/02; B29C 45/00

(52) U.S. Cl. 206/521; 206/592; 206/701; 264/328.14; 264/328.16; 156/245

(57) ABSTRACT

A manufacturing method of a packing cushion for electric equipments includes the steps of feeding, heating, closing mold, injection molding, cooling, opening mold and closing bottom. A recess is defined in a bottom of the packing cushion. A sealant is secured on the bottom of the packing cushion for closing the recess and forming a closed chamber that contains air for promoting the absorbing effect of the packing cushion.

### BACKGROUND OF THE INVENTION

1. Field of the Invention

The present invention relates to a manufacturing method of a packing cushion and a structure of the cushion, and more particularly to a manufacturing method of a packing cushion for electric equipments and the structure of the packing cushion.

2. Description of Related Art

A conventional packing cushion in accordance with the prior art contains gas therein for promoting the absorbing effect. With reference to FIG. 7, a method for manufacturing the conventional packing cushion blows hot air into a flexible plastic in a mold. However, the method only can be used to manufacture a packing cushion that has a simple structure. The packing cushion may form a thin portion (A) on a corner and a thick portion (B) where the material is heaped. As a result, the absorbing effect is reduced. Furthermore, the thin portion (A) may be cracked during being used.

For obviating the above problem, the thickness of the conventional packing cushion is raised. As a result, the requirement of material is wasted and the weight of the packing cushion is raised. Consequently, the conventional manufacturing method of a packing cushion needs to be advantageously altered.

Another manufacturing method of a packing cushion is provided to obviate the above problem. The method comprises steps of feeding, heating, shaping, cooling down with water, blowing, backing mold, cutting and closing bottom. The manufacturing method can obviate the above problem. However, the process of the method is complicated. As a result, the packing cushion can not be easily mass-produced.

The present invention has arisen to mitigate and/or obviate the disadvantages of the conventional manufacturing methods of a packing cushion.

### SUMMARY OF THE INVENTION

The main objective of the present invention is to provide an improved a manufacturing method of a packing cushion for electric equipments. The method simplifies the conventional manufacture process and saves material.

To achieve the objective, the manufacturing method in accordance with the present invention comprises the following steps.

Feeding: the tough plastic material is collected in a feeder of an injection molding machine.

Heating: the injection molding machine includes a heater that heats and melts the tough plastic material when the tough plastic material is fed into the heater.

Closing mold: the injection molding machine includes a core with a contour and a cavity. The contour is received in the cavity when the core and the cavity tightly abut each other.

Injection molding: the melted tough plastic material is injected within the core and the cavity for coating the contour and shaping a shell via an injection nozzle of the injection molding machine.

Cooling: the core and the cavity respectively include multiple cooling passages defined therein. The shell is rapidly cooled when water flows through the cooling passages in the core and the cavity.

Opening mold: the shell is automatically detached from the core when the shell is cooled and the mold is opened. A recess is defined in a bottom of the shell due to the contour of the core.

Closing the recess and finishing the packing cushion: a sealant is secured on the bottom of the shell for closing the recess and forming a closed chamber that contains air for promoting the absorbing effect of the packing cushion.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a manufacturing method of a packing cushion for electric equipments in accordance with the present invention;

FIG. 2 is a side plan view for showing a step of feeding of the method in FIG. 1;

FIG. 3 is a side plan view for showing a step of heating of the method in FIG. 1;

FIG. 4 is a side plan view for showing a step of shaping of the method in FIG. 1;

FIG. 5 is a side plan view for showing a step of backing mold of the method in FIG. 1;

FIG. 6 is a perspective view of a packing cushion that is manufactured by the method in accordance with the present invention; and

FIG. 7 is a cross-sectional view for showing a conventional method of shaping a packing cushion in accordance with the prior art.

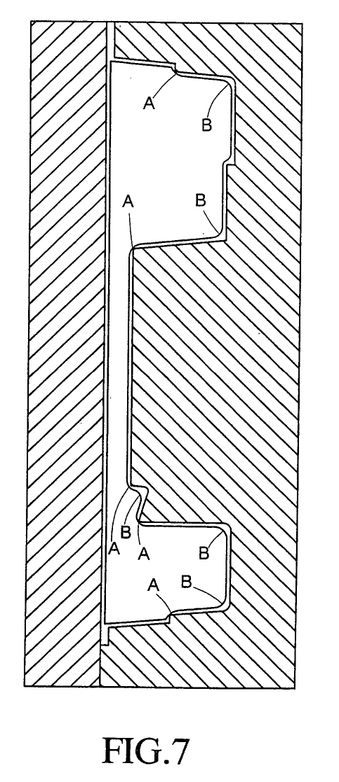

### DETAILED DESCRIPTION OF THE INVENTION

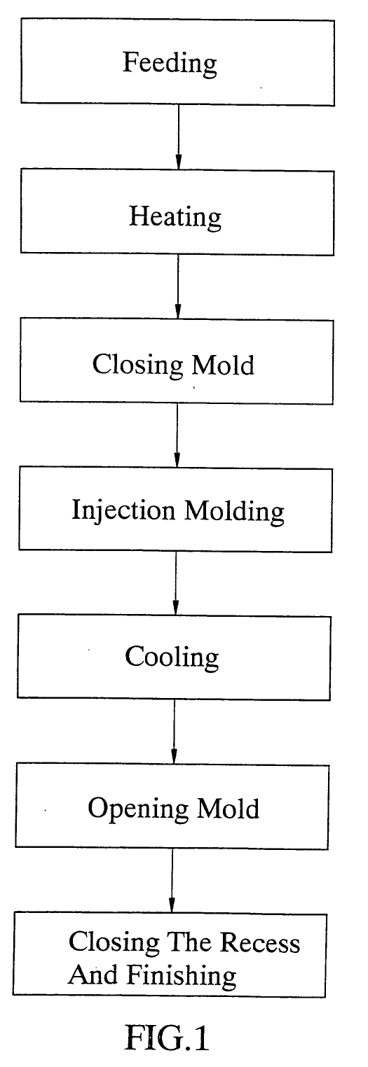

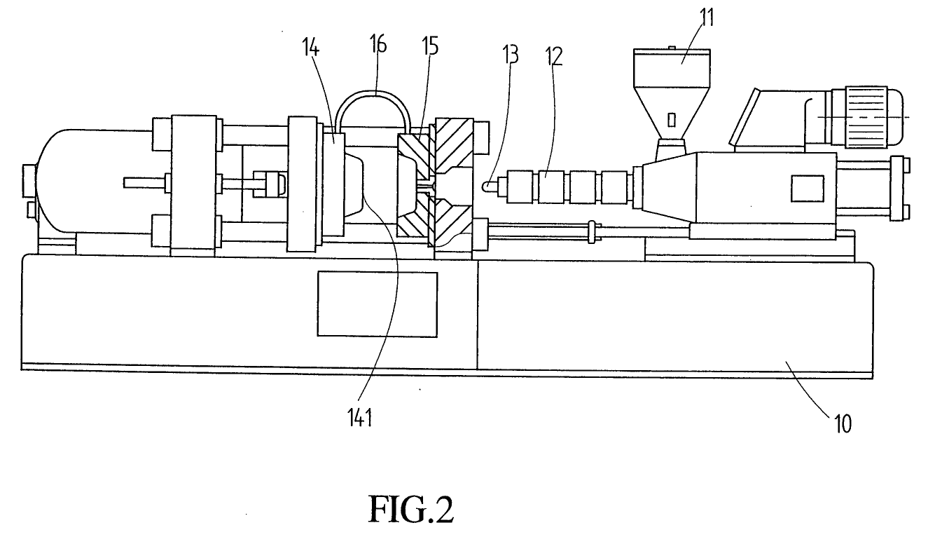

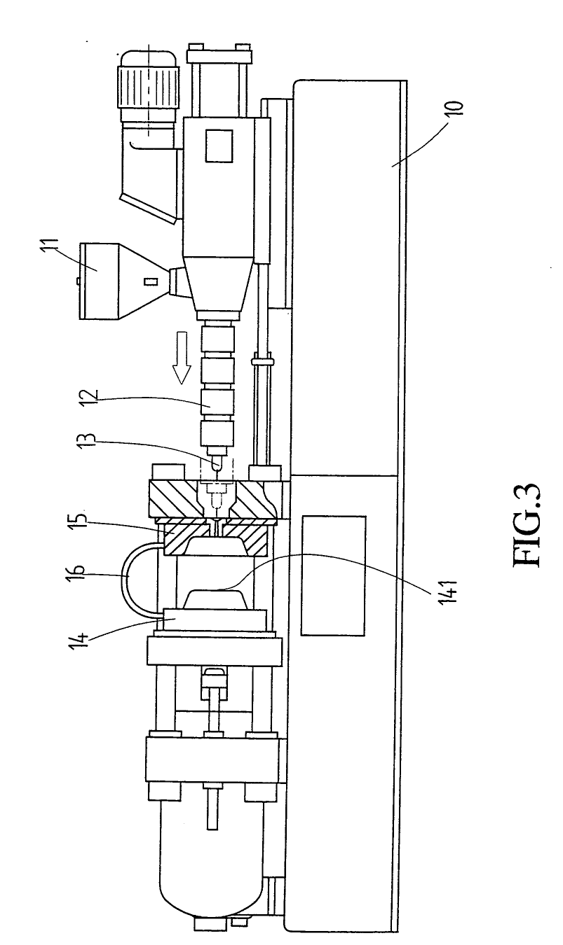

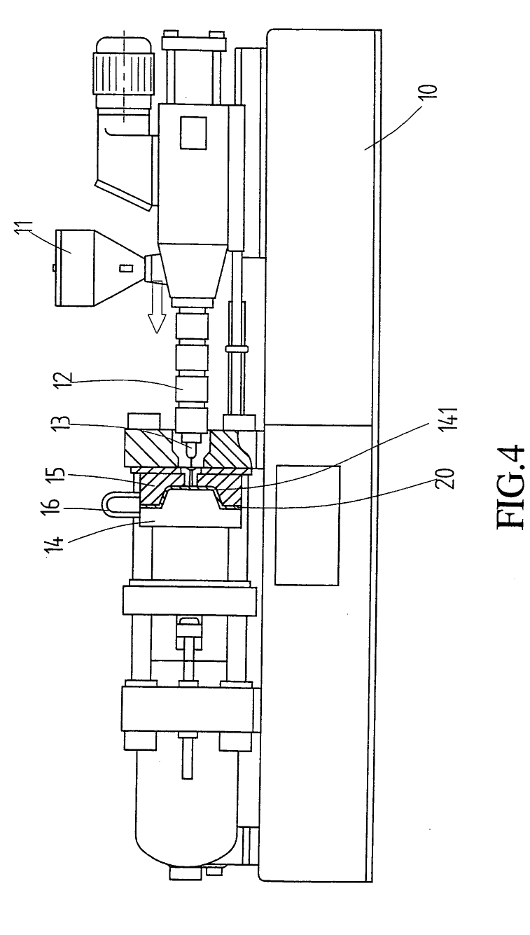

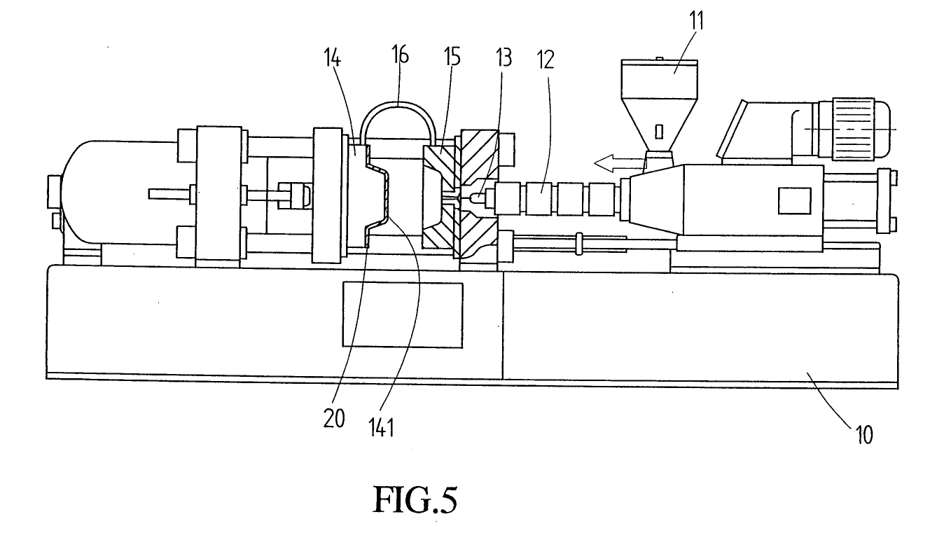

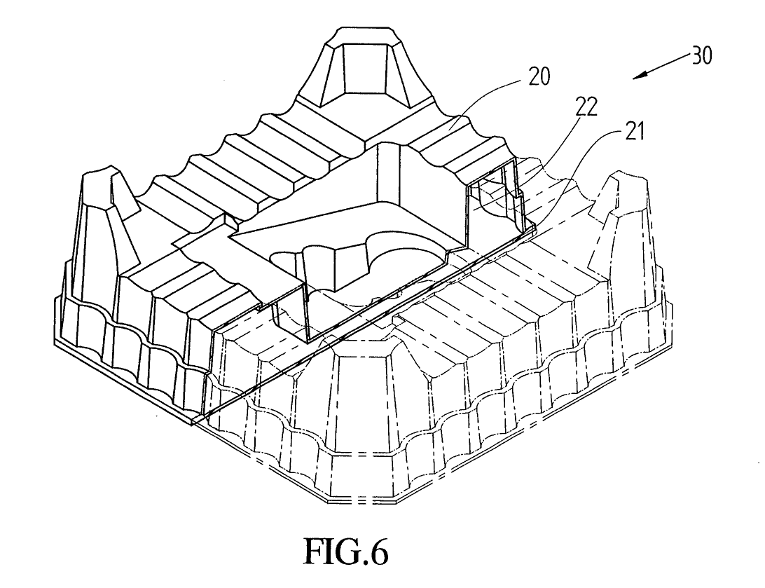

Referring to the drawings and initially to FIGS. 1-6, a manufacturing method of a packing cushion in accordance with the present invention comprises the following steps.

Feeding: the tough plastic material, such as polypropylene (PP), polyethylene terephthalate (PET), polyethylene (PE) and polyvinyl choride (PVC), is collected in a feeder (11) of an injection molding machine (10).

Heating: the injection molding machine (10) includes a heater (12) that heats and melts the tough plastic material when the tough plastic material is fed into the heater (12).

Closing mold: the injection molding machine (10) includes a core (14) with a contour (141) and a cavity (15). The contour (141) is received in the cavity (15) when the core (14) and the cavity (15) tightly abut each other.

Injection molding: the melted tough plastic material is injected within the core (14) and the cavity (15) for coating the contour (141) and shaping a shell (20) via an injection nozzle (13) of the injection molding machine (10).

Cooling: the core (14) and the cavity (15) respectively include multiple cooling passages (16) defined therein. The shell (20) is rapidly cooled when water flows through the cooling passages (16) in the core (14) and the cavity (15).

Opening mold: the shell (20) is automatically detached from the core (14) when the shell (20) is cooled and the mold is opened. A recess (22) is defined in a bottom of the shell (20) due to the contour (141) of the core (14).

Closing the recess (22) and finishing the packing cushion (30): a sealant (21) is secured on the bottom of the shell (20) for closing the recess (22) and forming a closed chamber that contains air for promoting the absorbing effect of the packing cushion (30).

The sealant (21) includes at least one through hole (not shown) defined therein for exhausting the air from the chamber to prevent the packing cushion (30) from cracking when the packing cushion (30) absorbs a shock.

Although the invention has been explained in relation to its preferred embodiment, it is to be understood that many other possible modifications and variations can be made without departing from the spirit and scope of the invention as hereinafter claimed.

What is claimed is:

1. A manufacturing method of a packing cushion for electric equipments, comprising the steps of:
feeding: the tough plastic material collected in a feeder of an injection molding machine;
heating: the injection molding machine including a heater that heats and melts the tough plastic material when the tough plastic material is fed into the heater;
closing mold: the injection molding machine including a core with a contour and a cavity, the contour received in the cavity when the core and the cavity tightly abut each other;
injection molding: the melted tough plastic material being injected within the core and the cavity for coating the contour and shaping a shell via an injection nozzle of the injection molding machine;
cooling: the core and the cavity respectively including multiple cooling passages defined therein, the shell rapidly cooled when water flows through the cooling passages in the core and the cavity;
opening mold: the shell automatically detached from the core when the shell is cooled and the mold is opened, a recess defined in a bottom of the shell due to the contour of the core; and
closing the recess and finishing the packing cushion: a sealant secured on the bottom of the shell for closing the recess and to form a closed chamber that contains air for promoting the absorbing effect of the packing cushion.

2. The method as claimed in claim 1, wherein the tough plastic material is polypropylene (PP).

3. The method as claimed in claim 1, wherein the tough plastic material is polyethylene (PE).

4. The method as claimed in claim 1, wherein the tough plastic material is polyethylene terephthalate (PET).

5. The method as claimed in claim 1, wherein the tough plastic material is polyvinyl choride (PVC).

6. A packing cushion for electric equipments comprises a shell having a recess defined in a bottom of the shell, a sealant secured on the bottom of the shell for closing the recess to form a closed chamber that contains air for promoting the absorbing effect of the packing cushion.

7. The packing cushion as claimed in claim 6, wherein the sealant comprises at least one through hole defined therein for exhausting the air from the chamber to prevent the packing cushion from cracking when the packing cushion absorbs a shock.
